(19) United States
(12) Patent Application Publication
(10) Pub. No.: US 2005/0260943 A1
(43) Pub. Date: Nov. 24, 2005

(54) Loading dock fan

(76) Inventors: Ronald P. Snyder, Dubuque, IA (US); Jason D. Miller, Monmouth, IA (US); Donald P. Grant, Dubuque, IA (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/851,283

(22) Filed: May 21, 2004

(51) Int. Cl. B60H 1/00

(52) U.S. Cl. 454/118

(57) ABSTRACT

A ventilation system for a trailer at a loading dock includes a fan supported by a positioning mechanism that can vary the extent to which the fan protrudes into the doorway. In some cases, the fan can protrude into the trailer itself to ensure airflow to the full depth of the trailer. When not in use, the fan can retract to a stored position where the fan is completely clear of the doorway, so the dock door can close. In some embodiments, the positioning mechanism includes an articulated arm with various pivot points that enable the fan to aim into a trailer at different angles and even move to another doorway to ventilate a different trailer. A lamp can be mounted to the fan and/or the fan's positioning mechanism.

### BACKGROUND OF THE INVENTION

1. Field of the Invention

The subject invention generally pertains to truck loading docks and more specifically to fan for ventilating a truck or trailer parked at the dock.

2. Description of Related Art

Trucks often back their trailers into a loading dock for loading or unloading the trailer of its cargo. Depending on the type of cargo, dockworkers may sometimes spend hours working inside the trailer as they move items in or out via a conveyor. While working inside the trailer, the temperature inside can get quite uncomfortable, particularly on hot days.

In an attempt to solve this problem, the first choice, of course, might be to install a fan to ventilate the trailer. D. L. Manufacturing of North Syracuse, N.Y., for example, provides an AEROTEC fan for just that purpose. Although the AEROTEC fan may provide some advantages over other more conventional fans, the AEROTEC fan and others still fall short of addressing all of the issues that may arise while trying to ventilate a trailer at a loading dock.

First, many trailers are 53 feet long and in some cases even longer. In order for a fan to force air from the doorway of the dock all the way over to the trailer's opposite end or nose of the trailer (front end of the trailer closest to the truck/tractor), the fan outlet is preferably aimed directly at the nose of the trailer. This, unfortunately, places the fan in front of the doorway, which can interfere with loading and unloading operations. The AEROTEC fan attempts to address this problem by using a diffuser that can break away when struck.

Second, having an AEROTEC or similar fan mounted at a fixed position means that the fan must be positioned sufficiently away from the doorway so as not to interfere with operation of the dock door. This, unfortunately, is not a good location for a fan. The discharge of the fan should preferably protrude well into the doorway and even into the trailer itself to avoid creating a static pressure or deadhead at the nose of the trailer that could impede fan discharge air from penetrating the full depth of the trailer.

Third, installing a fan at a fixed location makes it difficult to address ventilation needs that may change while the trailer is being loaded or unloaded. The discharge of the fan, for instance, may need to be redirected as the positions of the dockworkers and cargo within the trailer change.

Fourth, the effectiveness a fan mounted at a fixed location may vary depending on the location or alignment of the trailer opening relative to the doorway. If the back end of the trailer is higher or lower than expected or shifted laterally off to one side or the other, airflow through the trailer may be inadequate.

Fifth, loading docks often have a series of side-by-side doorways for servicing multiple trucks. If a fixed-location fan is dedicated to serving just one doorway, then each doorway may need its own fan. But, it may be costly to fully ventilate a multi-station loading dock with an equal number of fixed-location fans.

Even a movable floor mounted fan is not the best solution, as floor space in the area of a loading dock is often limited, traffic in the area can be heavy, and the airflow from a fan with a relatively low discharge may be obstructed by loads that are on the bed of the trailer. Thus, a need exists for an apparatus and method for more effectively ventilating a trailer at a loading dock.

### SUMMARY OF THE INVENTION

In some embodiments, a ventilation system for a trailer at a loading dock includes a fan supported by a positioning mechanism that renders the fan selectively movable to vary the extent to which the fan protrudes into the doorway.

In some embodiments, the positioning mechanism can move the fan to a stored position completely clear of the projected doorway passageway.

In some embodiments, the positioning mechanism includes a track and track follower that allows the fan to move linearly.

In some embodiments, the positioning mechanism includes an articulated arm with a plurality of pivot points that enable the mechanism to reach around a door track or other obstructions near the doorway.

In some embodiments, the articulated arm includes a telescoping segment for adjusting the arm's reach.

In some embodiments, the positioning mechanism permits the fan to rotate 360-degrees.

In some embodiments, the positioning mechanism allows a single fan to selectively operate at two or more doorways.

In some embodiments, a lamp is supported by the fan and/or the positioning mechanism.

In some embodiments, the positioning mechanism helps support a power cord that leads to the fan.

In some embodiments, the fan the positioning mechanism is mounted off the floor.

### BRIEF DESCRIPTION OF THE DRAWINGS

FIG. 1 is perspective view of a trailer being backed into a loading dock that includes a ventilation system according to the subject invention.

FIG. 2 is a top cross-sectional view of the loading dock of FIG. 1 but showing the trailer docked.

FIG. 3 is a back view of the ventilation system of FIG. 2 with the view taken from inside the building and looking out through the doorway and into the trailer.

FIG. 4 is similar to FIG. 2 but showing the fan in a stored position.

FIG. 5 is similar to FIG. 2 but showing the fan at another dock doorway.

FIG. 6 is a view similar to FIG. 3 but showing the fan in another orientation.

FIG. 7 is a view similar to FIG. 2 but showing the fan in yet another orientation.

FIG. 8 is a side view of the ventilation system of FIGS. 1-6.

FIG. 9 is a back view similar to FIG. 3 but showing another embodiment of a ventilation system.

FIG. 10 is a back view similar to FIG. 9 but showing the fan at a stored position.

### DESCRIPTION OF THE PREFERRED EMBODIMENT

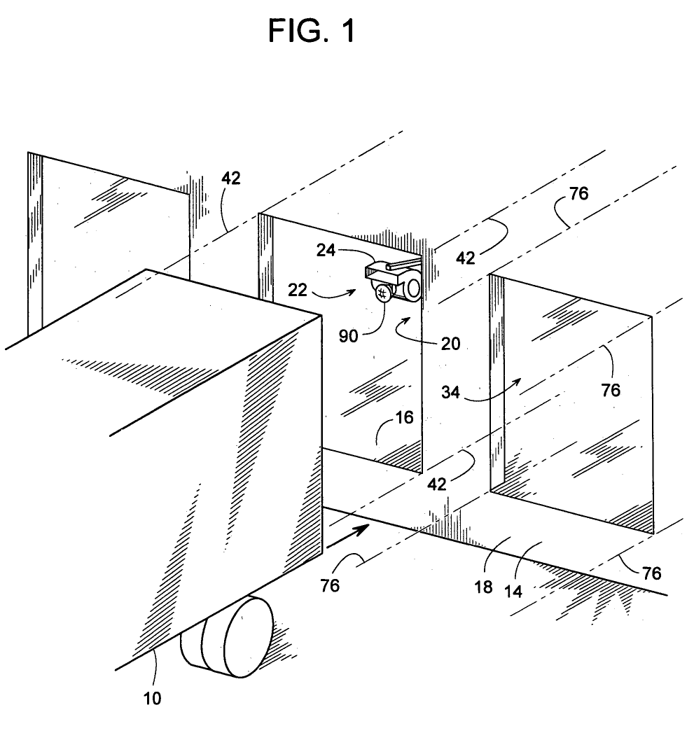

FIG. 1 shows a trailer 10 of a truck being backed into a loading dock 12 of a building 14. To facilitate the loading and unloading of cargo off an elevated trailer bed, building 14 includes a comparably elevated floor or platform 16, a wall 18, and a doorway 20 defined by wall 18. Additional items that are not shown but are often found at a loading dock include a dock leveler, dock bumpers, vehicle restraint, and a dock shelter or dock seal. The structure, function and purpose of such additional items are well known to those of ordinary skill in the art, so they have been omitted to more clearly illustrate the invention.

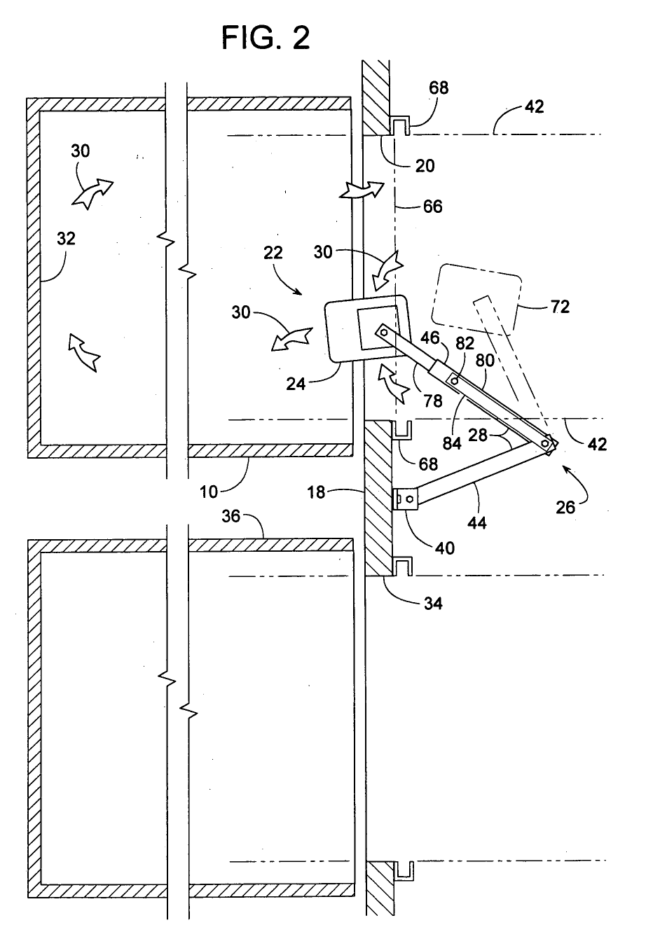

To help ventilate the interior of trailer 10 once it is docked, as shown in FIG. 2, dock 12 is provided with a ventilation system 22. Ventilation system 22 comprises a fan 24 with a fan support 26 that makes system 22 particularly suited for ventilating the interior of a trailer at a loading dock. More specifically, fan support 26 includes a positioning mechanism 28 that renders fan 24 to be selectively movable such that fan 24 can move to various positions and orientations depending on the need.

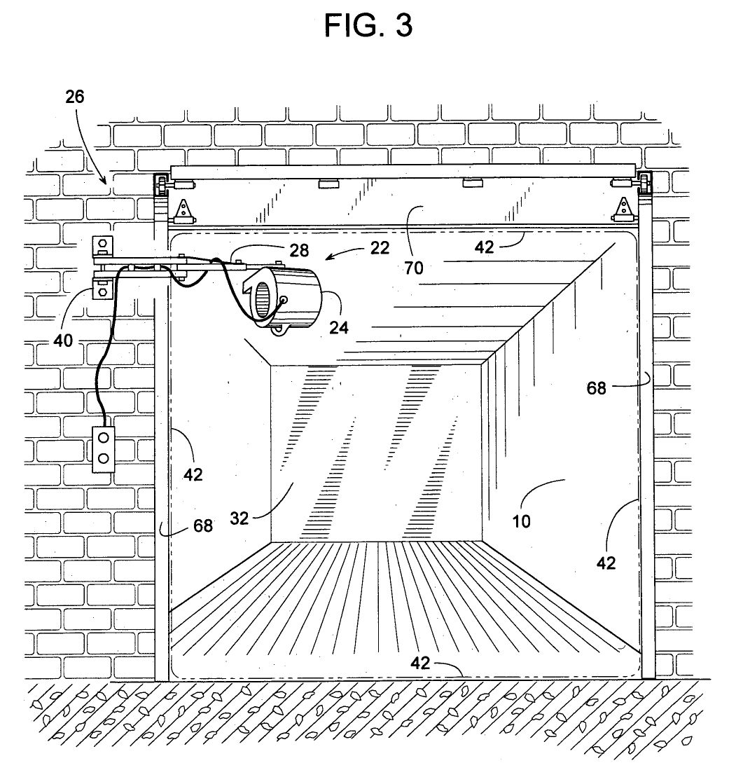

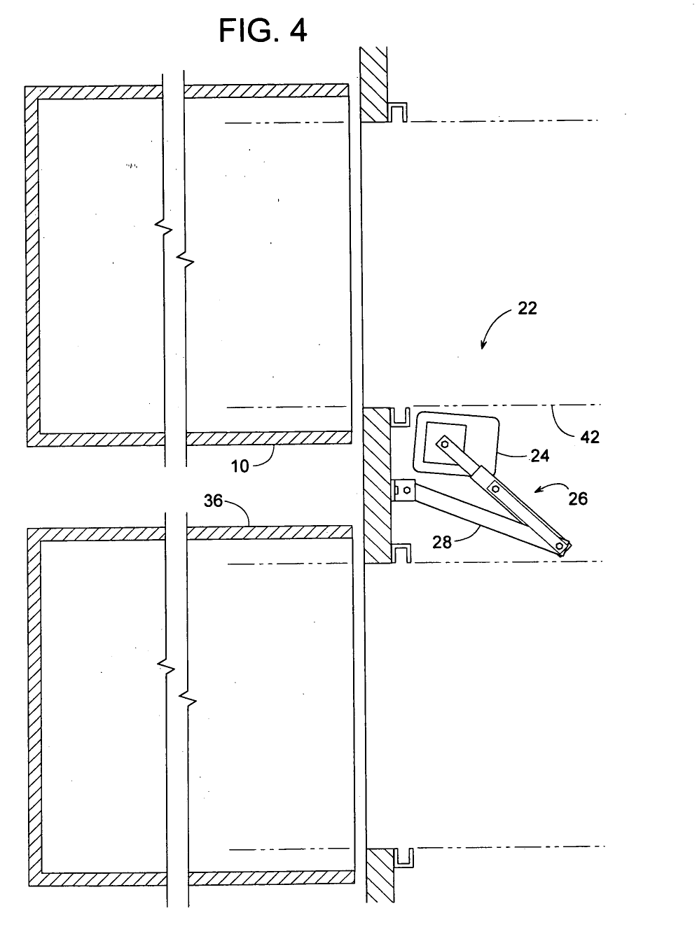

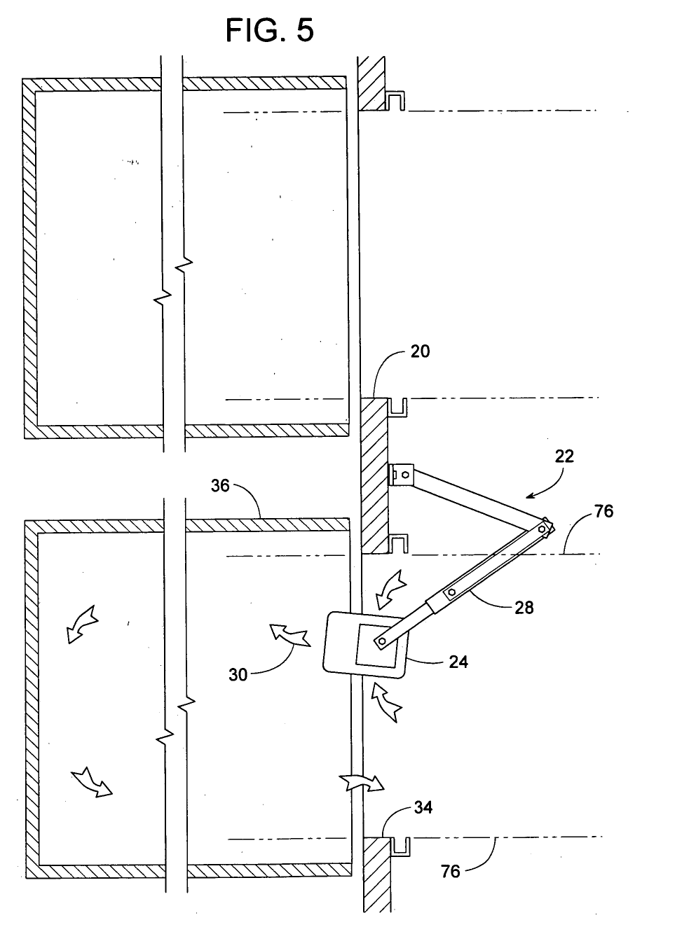

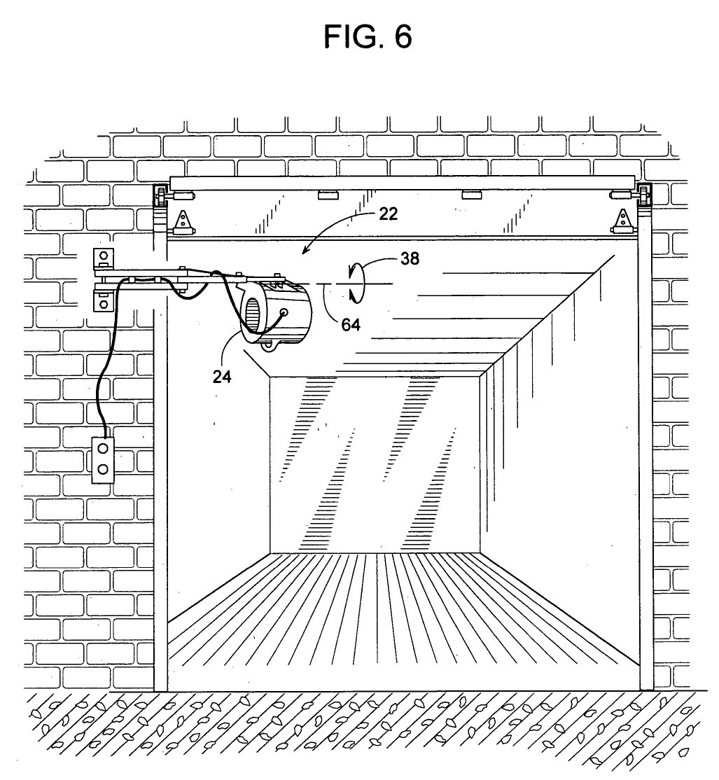

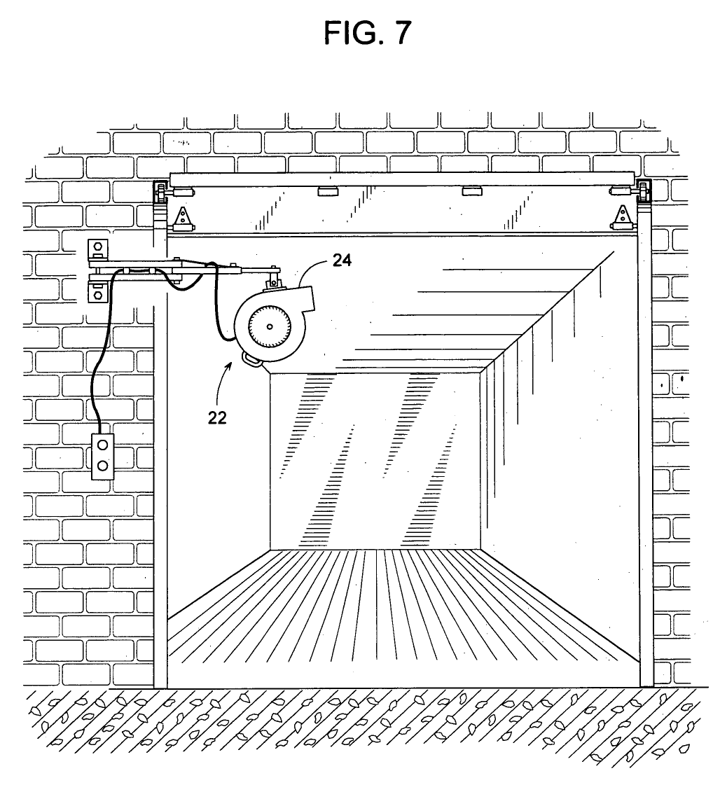

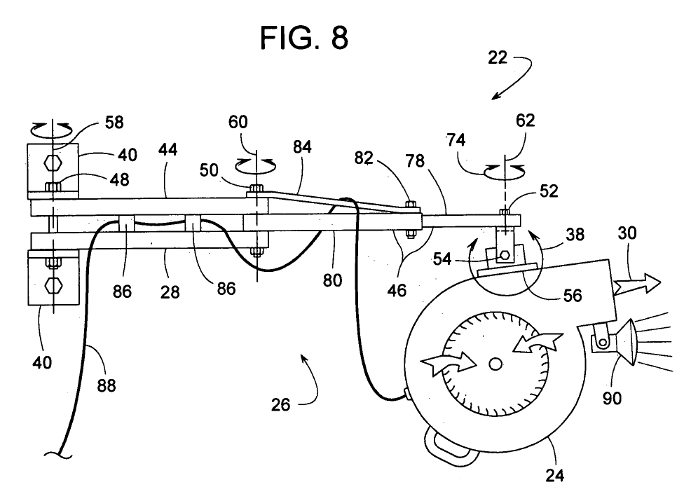

To ventilate trailer 10, mechanism 28 can allow movement of fan 24 to direct air 30 towards a front end 32 of trailer 10, as shown in FIGS. 2 and 3. Mechanism 28 can also allow movement of fan 24 to a stored position, as shown in FIG. 4. In some cases, mechanism 28 can even move fan 24 to direct air through another doorway 34 to ventilate a different trailer 36, as shown in FIG. 5. If airflow is needed at higher or lower elevations, mechanism 28 can also allow a tilting movement of fan 24 as indicated by arrow 38 of FIGS. 6 and 8. If it is preferred to force air through a trailer by drawing the air out from within the trailer, mechanism 28 can also allow the positioning of fan 24 as shown in FIG. 7. Additional structural and functional details of ventilation system 22 will now be described with reference to a particular embodiment of system 22.

Referring further to FIG. 8, in some cases, fan support 26 comprises positioning mechanism 28 and a base 40. Base 40 can be anchored in a suitable manner to wall 18 or some other fixed location adjacent to doorway 20. The term, “adjacent to doorway 20” means that base 40 is sufficiently close to doorway 20 to allow mechanism 28 to place and support at least a portion of fan 24 within a doorway projection 42 of doorway 20. The term, “doorway projection 42” refers to a volume of space defined or circumscribed by an outer perimeter of doorway 20 and extending perpendicular to wall 18.

Referring to FIG. 8, to provide fan 24 with a broad range of movement, positioning mechanism 28 comprises a first arm 44 and a second arm 46 with several pivot points. A first pin 48 pivotally connects first arm 44 to base 40, a second pin 50 pivotally connects arms 44 and 46, a third pin 52 pivotally connects second arm 46 to fan 24, and a fourth pin 54 pivotally connects a base plate 56 of fan 24 to second arm 46. Pins 48, 50, 52 and 54 make mechanism 28 an articulated arm that allows fan 24 to pivot about axis 58, 60, 62 and 64 respectively (axis 64 is shown in FIG. 6).

With this design, fan 24 can be moved selectively in and out across an imaginary door plane 66 defined by an exterior face of a door 70 (FIG. 3) that travels along a pair of door guides 68 (FIG. 2). In the extended position of FIG. 2, fan 24 intersects door plane 66 and perhaps even protrudes into trailer 10 to ensure that fan 24 forces air into the trailer. In a retracted position (shown by phantom lines 72 of FIG. 2), fan 24 is spaced apart from door plane 66 to allow door 70 of doorway 20 to close. In the stored position of FIG. 4, fan 24 is positioned completely beyond doorway projection 42 so as not to obstruct any cargo being transferred in or out of trailer 10. Pin 54 enables the vertical tilting of fan 24, as shown in FIG. 6. And pin 52 allows fan 24 to rotate 360-degrees (see rotational arrow 74 of FIG. 8), so fan 24 can be rotated from its position of FIG. 2 to that of FIGS. 4, 5 and 7. In FIG. 5, fan 24 is shown extending into a doorway projection 76 of doorway 34.

To help hold fan 24 in place once it is properly positioned, pins 48, 50, 52 and 54 can each be a screw with a locknut that is sufficiently tightened to create a frictional holding force at each pivotal axis 58, 60, 62 and 64.

To ensure that positioning mechanism 28 has sufficient length for reaching various desired locations, second arm 46 may comprise a telescoping segment 78 that fits within an outer tube 80. The resulting telescoping assembly can be locked in place once arm 46 is set at a desired length, or arm 46 can be left with its telescoping feature. In some cases, the telescoping assembly is locked in place by a screw 82 that connects one end of a brace 84 that extends between pin 50 and screw 82. Brace 84 reinforces arm 46 by countering the bending moment created by the weight of fan 24.

First arm 28 can be provided with some braces 86 that not only reinforce arm 44 but also provides a way for a power cord 88 of fan 24 to be threaded through and supported by first arm 28.

To illuminate the interior of trailer 10, a lamp 90 can be coupled to base 40 by attaching lamp 90 to fan 24 (FIG. 8), attaching lamp 24 to mechanism 26, or by attaching lamp 24 to base 40 via an addition linkage between lamp 24 and base 40.

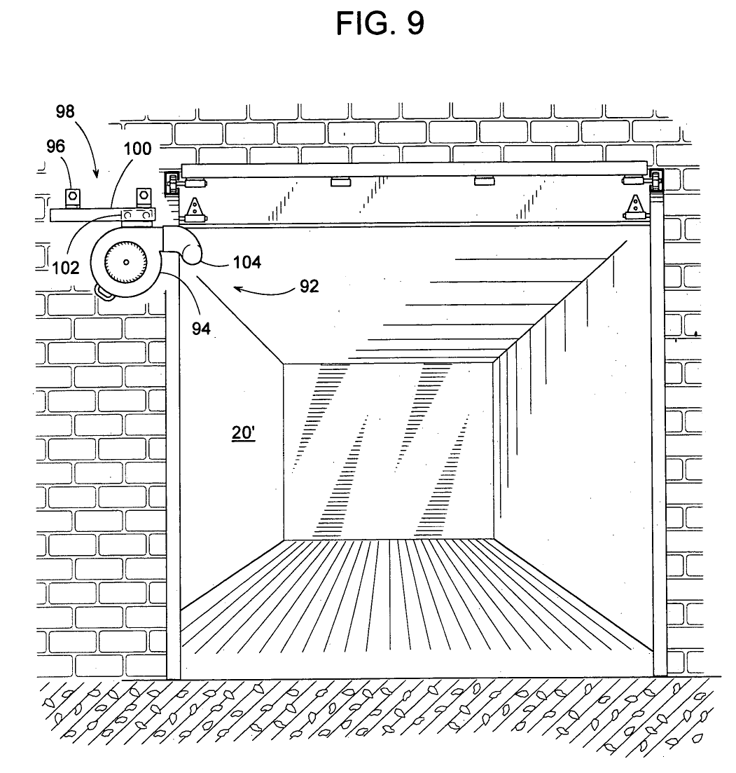

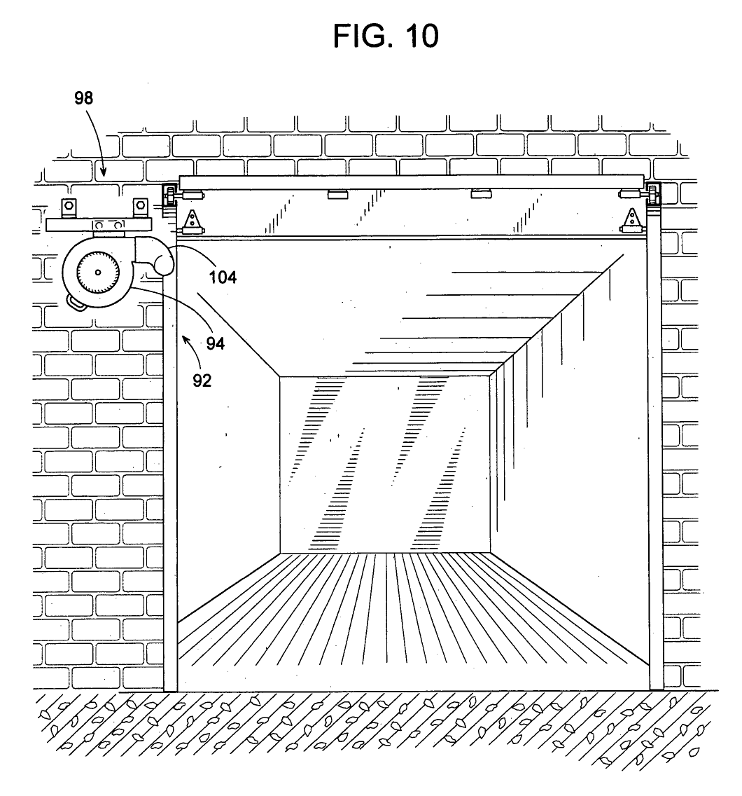

FIGS. 9 and 10 show another embodiment of a ventilation system 92 where a fan 94 is movably coupled to a fixed base 96 by way of a positioning mechanism 98 that includes a track 100 and a track follower 102. Base 96 can be installed at a fixed location adjacent to one or more doorways 20′, and track 100 can be attached to base 96. Track follower 102 can be a sliding or rolling device that can travel along the length of track 100. Fan 94 is attached to track follower 102 so that fan 94 can translate in and out of a doorway projection of doorway 20′. If the building includes two or more adjacent dock doorways and track 100 is sufficiently long, fan 94 may be able to selectively serve more than one doorway.

In this example, fan 94 includes a flexible diffuser 104 that can resiliently recover from an impact should it occur. Diffuser 104 can be made of a tough fabric or some other impactable material. Diffuser 104 can also be installed on fan 24 of ventilation system 22. Alternatively, a diffuser could be mounted elsewhere—such as to the interior of the trailer—and then coupled to the fan 94. In this context, the “diffuser” could actually be an extended duct (of fabric or other material) extending along or across the interior of the trailer. Such an arrangement would allow the duct diffuser to carry air in a contained, directed manner, further into the trailer. It should also be noted that other advantageous structure besides diffuser 104 could be attached to the fan, such as a filter for the conveyed air, a heater for the air and/or a dehumidifier. These three illustrative, representative structures as well as the diffuser 104 are referred to herein as “air treatment components.”

Although the invention is described with reference to a preferred embodiment, it should be appreciated by those of ordinary skill in the art that various modifications are well within the scope of the invention. For example, although fans 24 and 94 are illustrated as centrifugal fans, other types of fans could also be used. Also, lamp 90 shown mounted to fan 24 of FIG. 8 could be omitted or attached to fan 94 of FIGS. 9 and 10. Therefore, the scope of the invention is to be determined by reference to the following claims:

1. A ventilation system for use at a loading dock, wherein the loading dock includes a wall that defines at least of first doorway with a first doorway projection, wherein the first doorway projection is a volume of space circumscribed by an outer perimeter of the first doorway and extending perpendicular to the wall, the ventilation system comprising:
a fan support that includes a base and a positioning mechanism, wherein the base can be anchored at a fixed location adjacent to the first doorway; and
a fan coupled to the base via the positioning mechanism, wherein the positioning mechanism can be manipulated to vary an extent to which the fan extends into the first doorway projection.

2. The ventilation system of claim 1, wherein the fan includes a flexible diffuser that extends farther into the first doorway projection than does the rest of the fan.

3. The ventilation system of claim 1, wherein the positioning mechanism renders the fan movable to a stored position that is completely beyond the first doorway projection.

4. The ventilation system of claim 1, wherein the fan can translate substantially horizontally.

5. (canceled)

6. The ventilation system of claim 1, wherein the positioning mechanism includes a pivotal arm that enables the fan to rotate about a first axis.

7. The ventilation system of claim 6, wherein the pivotal arm enables the fan to rotate about a second axis spaced apart from the first axis.

8. The ventilation system of claim 7, wherein the pivotal arm enable the fan to rotate about a third axis that is spaced apart from the first axis and the second axis.

9. The ventilation system of claim 1, wherein positioning mechanism enables the fan to be selectively positioned within the first doorway projection and a second doorway projection, wherein the wall defines a second doorway by which the second doorway projection is defined.

10. The ventilation system of claim 1, further comprising a lamp coupled to the base.

11. The ventilation system of claim 10, wherein the fan supports the lamp.

12. The ventilation system of claim 1, wherein the fan includes a power cord that is at least partially supported by the fan support.

13. The ventilation system of claim 1, wherein at least one air treatment component is attached to the fan.

14. The ventilation system of claim 13, wherein the at least one air treatment component is a filter.

15. The ventilation system of claim 13, wherein the at least one air treatment component is a heater.

16. The ventilation system of claim 13, wherein the at least one air treatment component is a dehumidifier.

17. A ventilation system for use at a loading dock, wherein the loading dock includes a wall that defines at least of first doorway with a first doorway projection, wherein the first doorway projection is a volume of space circumscribed by an outer perimeter of the first doorway and extending perpendicular to the wall, the ventilation system comprising:
a fan;
a base that can be anchored at a fixed location adjacent to the first doorway; and
a pivotal arm that couples the fan to the base such that the fan can pivot about a first axis, wherein the pivotal arm renders the fan selectively movable to an operative position within the first doorway projection and a stored position where the fan is completely beyond the first doorway projection.

18. The ventilation system of claim 17, wherein the fan includes a flexible diffuser that extends farther into the first doorway projection than does the rest of the fan.

19. The ventilation system of claim 17, wherein the pivotal arm enables the fan to rotate about a second axis spaced apart from the first axis.

20. The ventilation system of claim 17, wherein the pivotal arm enable the fan to rotate about a third axis that is spaced apart from the first axis and the second axis.

21. The ventilation system of claim 17, wherein positioning mechanism enables the fan to be selectively positioned within the first doorway projection and a second doorway projection, wherein the wall defines a second doorway by which the second doorway projection is defined.

22. The ventilation system of claim 17, further comprising a lamp coupled to the base.

23. The ventilation system of claim 22, wherein the fan supports the lamp.

24. The ventilation system of claim 17, wherein the fan includes a power cord that is at least partially supported by the pivotal arm.

25. The ventilation system of claim 17, wherein at least one air treatment component is attached to the fan.

26. The ventilation system of claim 25, wherein the at least one air treatment component is a filter.

27. The ventilation system of claim 25, wherein the at least one air treatment component is a heater.

28. The ventilation system of claim 25, wherein the at least one air treatment component is a dehumidifier.

29. A ventilation method for a loading dock, wherein the loading dock includes a wall that defines a first doorway and a second doorway, the ventilation method comprising:
anchoring a base at a substantially fixed location relative to the first doorway and the second doorway;
coupling a fan to the base so that the base can help support the fan; and
moving the fan between the first doorway and the second doorway to selectively force air through the first doorway and the second doorway.

30. The method of claim 29, wherein the step of moving the fan involves pivoting the fan about a first axis.

31. The method of claim 30, wherein the step of moving the fan involves pivoting the fan about a second axis that is spaced apart from the first axis.

32. The method of claim 31, wherein the step of moving the fan involves pivoting the fan about a third axis that is spaced apart from the first axis and the second axis.

33. The method of claim 29, further comprising coupling a lamp to the base so that the base can help support the lamp.

34. The method of claim 29, further comprising attaching a lamp to the fan.

35. The method of claim 29, further comprising attaching at least one air treatment component to the fan.

36. The method of claim 35, wherein the at least one air treatment component is a filter.

37. The method of claim 35, wherein the at least one air treatment component is a heater.

38. The method of claim 35, wherein the at least one air treatment component is a dehumidifier.

39. A ventilation method for a loading dock, wherein the loading dock includes a door associated with a wall that defines a doorway, wherein the door at its closed position defines an imaginary door plane that lies along an exterior face of the door, the ventilation method comprising:
anchoring a base at a substantially fixed location relative to the door;
coupling a fan to the base so that the base can help support the fan; and
moving the fan between an extended position and a retracted position, wherein the fan intersects the imaginary door plane when the fan is in the extended position and the fan is spaced apart from the imaginary door plane when the fan is in the retracted position, whereby the extended position promotes ventilation and the retracted position permits door operation.

40. The method of claim 39, wherein the fan includes a flexible discharge diffuser that intersects the imaginary door plane when the fan is in the extended position and the flexible discharge diffuser is spaced apart from the imaginary door plane when the fan is in the retracted position

41. The method of claim 39, wherein the step of moving the fan involves pivoting the fan about a first axis.

42. The method of claim 41, wherein the step of moving the fan involves pivoting the fan about a second axis that is spaced apart from the first axis.

43. The method of claim 42, wherein the step of moving the fan involves pivoting the fan about a third axis that is spaced apart from the first axis and the second axis.

44. The method of claim 39, further comprising coupling a lamp to the base so that the base can help support the lamp.

45. The method of claim 39, further comprising attaching a lamp to the fan.

46. The method of claim 39, further comprising attaching at least one air treatment component to the fan.

47. The method of claim 46, wherein the at least one air treatment component is a filter.

48. The method of claim 46, wherein the at least one air treatment component is a heater.

49. The method of claim 46, wherein the at least one air treatment component is a dehumidifier.
